(19) United States
(12) Patent Application Publication
(10) Pub. No.: US 2008/0179976 A1
(43) Pub. Date: Jul. 31, 2008

(54) Vibrating mechanism of a body vibration machine

(75) Inventor: Mu-Chuan Wu, Tainan Hsien (TW)

Correspondence Address: BACON & THOMAS, PLLC, 625 SLATERS LANE, FOURTH FLOOR, ALEXANDRIA, VA, 22314, US

(73) Assignee: Tonic Fitness Technology, Inc., Tainan Hsien (TW)

(21) Appl. No.: 11/698,826

(22) Filed: Jan. 29, 2007

(51) Int. Cl. A61H 1/00; H02K 7/075; H02K 7/10

(52) U.S. Cl. 310/80; 601/46; 601/78

(57) ABSTRACT

A vibrating mechanism of a body vibration machine includes a step, a bottom board and a driving mechanism that has upper linking bars and lower linking bars connected with the step and the bottom board, and plural direction-restricting sets installed between the step and the bottom board. Each position-restricting set has a cylinder and a guiding bar inserted in the cylinder to enable the step moved vertically. A crank is connected with the upper linking bar and the lower linking bar via a pivotal shaft so that it can spontaneously drive the pivotal shaft to move circularly, enabling the step to move vertically. Moreover, a small motor is powerful enough as the step is driven to move by the upper and the lower linking bar instead of the driving motor directly.

### BACKGROUND OF THE INVENTION

1. Field of the Invention

This invention relates to a vibrating mechanism of a body vibration machine, particularly to one that demands only a relatively small driving motor to move its step vertically in a stable amplitude of vibration.

2. Description of the Prior Art

Commonly, there are various sorts of conventional body vibration machines. As shown in FIGS. 1˜3, a first conventional body vibration machine includes a vibrating motor 10 able to work eccentrically, and a connecting body 11 positioned on the top of the vibrating motor 10 for fixing with the bottom of a step 12 to keep the vibrating motor 10 hung in the air. In addition, there are plural pairs of direction-restricting posts 13 positioned correspondingly on two lateral sides of a bottom base 14, used to support the step 12. Because the step 12 is supported by the direction-restricting posts 13, the M (the amplitude of vibration of the step 12) is directly proportional to the ΣF (resultant force), wherein ΣF=F (centrifugal force)−L (load). That is, when the L (the weight of a man standing on the step 12) is increased, the ΣF is to become smaller, obtaining a relatively smaller M. On the contrary, a larger M is to be attained if the step 12 is loaded with a lighter person. Therefore, the M is to alter in accordance with the weight of the person standing on the step 12, becoming unsteady. Moreover, as the vibrating motor 10 is fixed with the step 12 to work eccentrically and the step 12 is supported by the direction-restricting rods 13, the step 12 is to be vibrated in X-, Y- and Z-direction, unable to move just up and down.

Additionally, as shown in FIG. 4(A,B,C,D), a second conventional body vibration machine is provided with a driving motor 20, a rotator 21 fixed on a spindle 200 of the driving motor 20, a crank 22 pivotally connected at an eccentric position 211 of the rotator 21, and a step 23 having its bottom side pivotally fixed with the other end of the crank 22. There are also plural pairs of tubular posts 24 positioned correspondingly at two sides of the driving motor 20 and each tubular post 24 is installed with a guiding bar 26 inside it. The tubular post 24 and the driving motor 20 are all fixed on a bottom base 25. The guiding bars 26 are fixed together with the step 23 at their top ends. In using, when the driving motor 20 is turned on, the rotator 21 is driven to rotate, and the crank 22 is thus driven by the rotator 21 to rotate spontaneously, enabling the step 23 to move and vibrate just up and down as the guiding bars 26 are restricted to move inside the tubular posts 24. And, because the crank 22 is connected with the step 23 by its one end and with the rotator 21 by the other end, the step 23 is able to maintain stable vibration without being affected by a body's weight, overcoming the defect of the first conventional body vibration machine. But, in order to directly drive the step 23 to move up and down, the driving motor 20 needs to be more powerful to do the job, resulting in a high cost.

### SUMMARY OF THE INVENTION

The objective of this invention is to offer a vibrating mechanism of a body vibration machine, which can move a step vertically in a steady amplitude of vibration and does not need a large powerful driving motor so as to save cost.

The main characteristics of the invention are a step, a bottom board and a driving mechanism. The driving mechanism is provided with two upper linking bars and two lower linking bars connected respectively with the step and the bottom board, and plural direction-restricting sets correspondingly installed between the step and the bottom board. Each of the direction-restricting sets has a cylinder fixed on the bottom board and a guiding bar inserted in the cylinder and connected with a bottom of the step to enable the step moved merely up and down. A crank is pivotally connected together with the upper linking bar and the lower linking bar by means of a pivotal shaft, so that the crank can spontaneously drive the pivotal shaft to move circularly to enable the step to move just up and down. And, instead of being driven by the driving motor directly, the step is driven by the upper linking bar and the lower linking bar to move up and down, able to save cost by using a smaller driving motor.

### BRIEF DESCRIPTION OF DRAWINGS

This invention is better understood by referring to the accompanying drawings, wherein:

FIG. 1 is an exploded perspective view of a body vibration machine with a first conventional vibrating mechanism;

FIG. 2 is a side view of the body vibration machine with the first conventional vibrating mechanism, showing it not being pressed down;

FIG. 3 is a side view of the body vibration machine with the first conventional vibrating mechanism, showing it being pressed down;

FIG. 4(A,B,C,D) is a side view of a body vibration machine with a second conventional vibrating mechanism, showing it being pressed down and how it functions;

FIG. 5 is a perspective view of a preferred embodiment of a vibrating mechanism of a body vibration machine in the present invention;

FIG. 6 is an exploded perspective view of the preferred embodiment of a vibrating mechanism of a body vibration machine in the present invention;

FIG. 7 is a top view of the preferred embodiment of a vibrating mechanism of a body vibration machine in the present invention;

FIG. 8 is a side view of the preferred embodiment of a vibrating mechanism of a body vibration machine in the present invention, showing a step is moved to a highest level;

FIG. 9 is a side view of the preferred embodiment of a vibrating mechanism of a body vibration machine in the present invention, showing the step is moved to a lowest level; and

FIG. 10(A,B,C,D) is a side view of the preferred embodiment of a vibrating mechanism of a body vibration machine in the present invention, showing how it works.

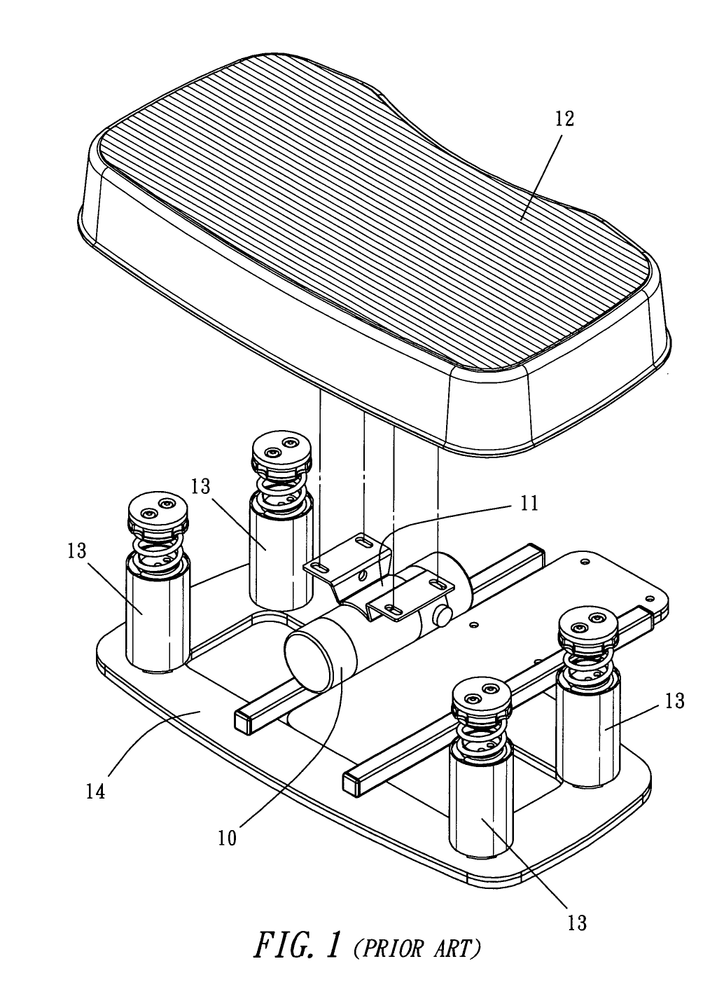

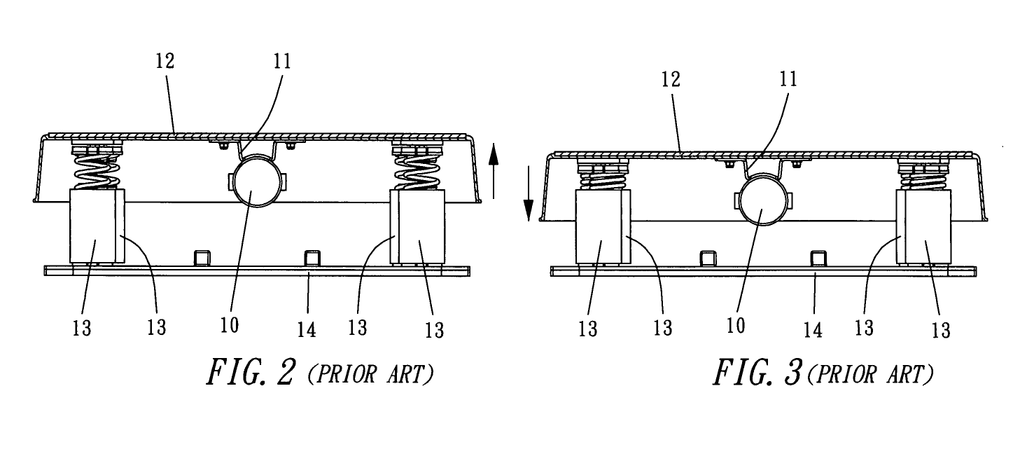

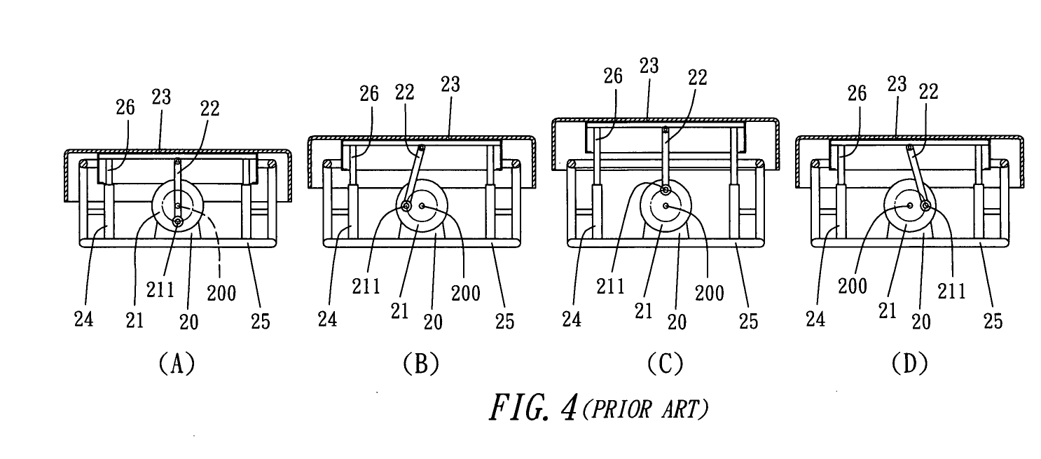

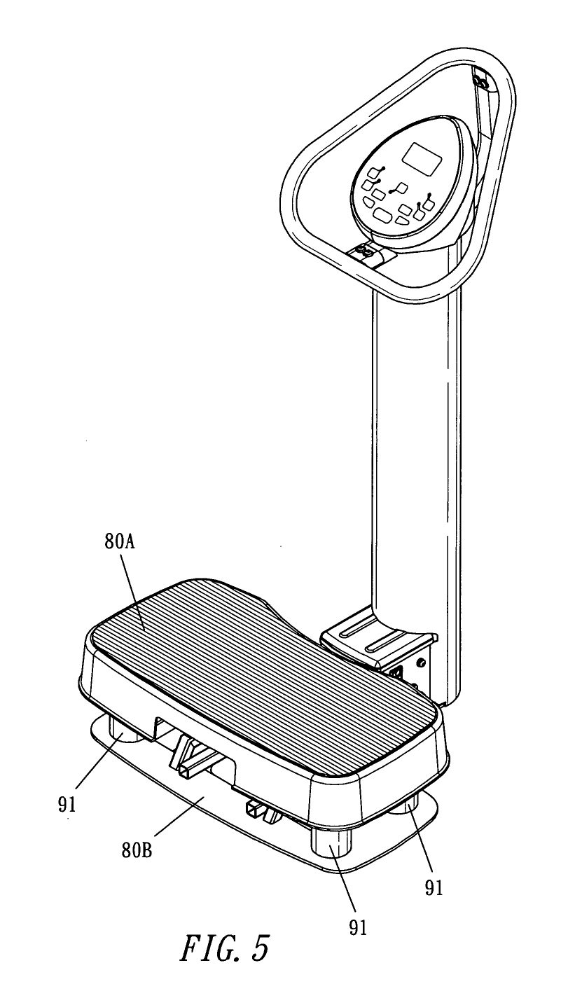

### DETAILED DESCRIPTION OF THE PREFERRED EMBODIMENT

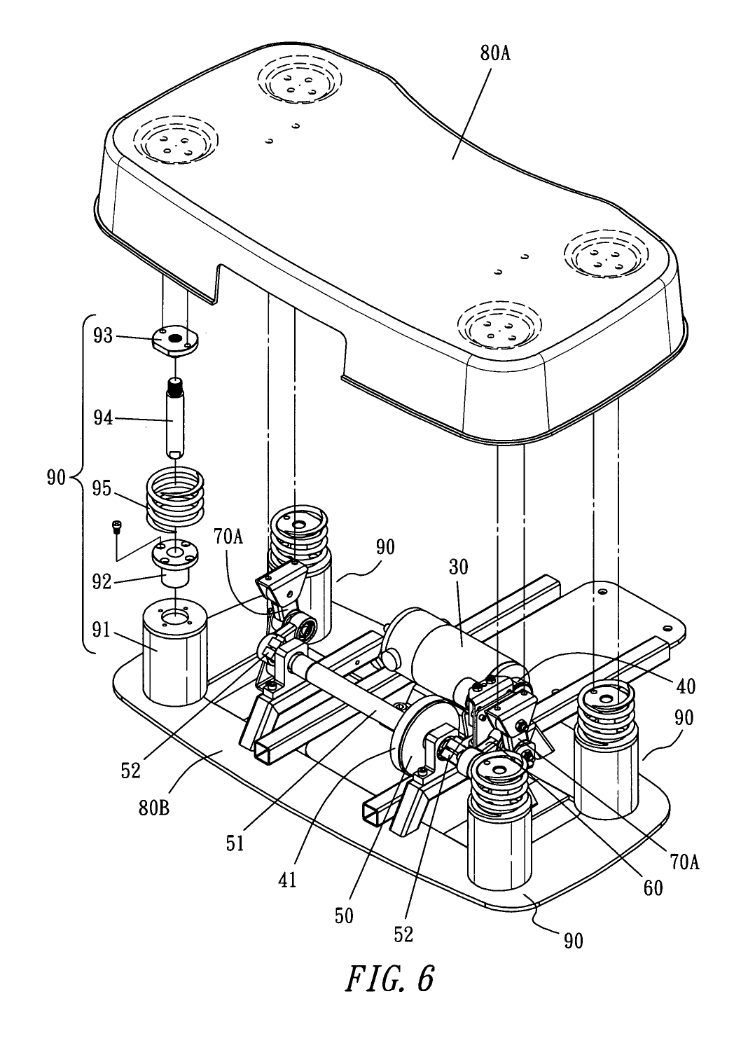

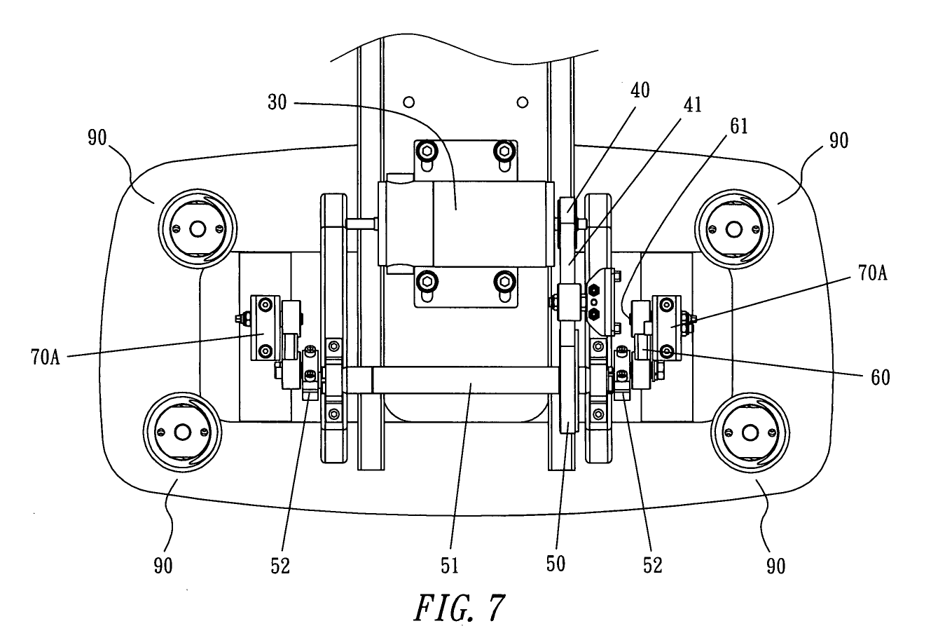

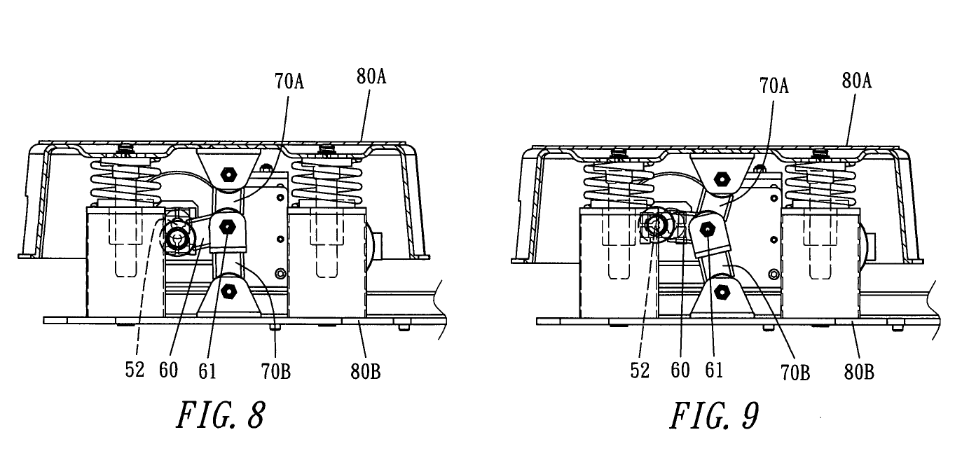

As shown in FIGS. 5˜9, a preferred embodiment of a vibrating mechanism of a body vibration machine in the present invention includes a step 80A, a bottom board 80B and a driving mechanism. The driving mechanism is composed of a driving motor 30, a small pulley 40 fixed on a spindle of the driving motor 30, a larger pulley 50 linked with the small pulley 40 via a belt 41, two upper linking bars 70A connected with the step 80A and two lower linking bars 70B connected with the bottom board 80B. The large pulley 50 is provided with an axial shaft 51 that is connected pivotally with an eccentric rod 52 at its two ends respectively. Each eccentric rod 52 is connected pivotally with a crank 60 by its other end. The crank 60 is provided with a pivotal shaft 61 located at the other end for connecting pivotally with an upper linking bar 70A and a lower linking bar 70B, so that the crank 60 can drive the pivotal shaft 61 to rotate circularly to drag the upper linking bar 70A and the lower linking bar 70B, as shown in FIGS. 8, 9 and 10. There are four direction-restricting sets 90 positioned at four corners of the bottom board 80B for elastically supporting the step 80A. And, as shown in FIGS. 6 and 8, each of the direction-restricting sets 90 is provided with a cylinder 91 fixed on the bottom board 80B, a bush 92 fixed on the top of the cylinder 90, a positioning disc 93 fixed on the bottom of the step 80A to face exactly to a cylinder body 91. The positioning disc 93 is provided with a female-threaded hole for screwing with a male-threaded portion located at a top end of a guiding bar 94 that is to be inserted into the cylinder body 91 through the bush 92, in order to restrict the step 80A moving just up and down without swinging. In addition, a spring 95 is installed between the bush 92 and the positioning disc 93 for elastically supporting the step 80A.

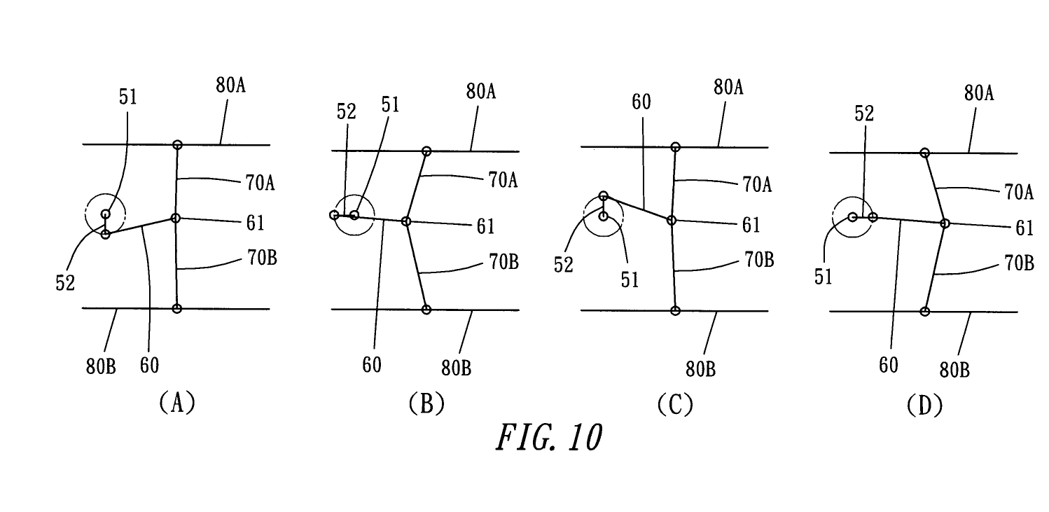

In using, as shown in FIG. 10, when the driving motor 30 is turned on, the eccentric rod 52 is to be driven by the shaft 51 of the large pulley 50 to do a circular motion. The crank 60 is then spontaneously driven to enable the pivotal shaft 61 to move circularly, keeping the upper linking bar 70A and the lower linking bar 70B dragged to move. And, because the step 80A is directly connected with and limited by the upper linking bar 70A and the lower linking bar 70B and the guiding bar 94 of the direction-restricting set 90 is inserted inside the cylinder body 91 and the bush 92, it can only move up and down in a steady amplitude of vibration. Also, instead of being driven by the driving motor 30 directly, the step 80A is dragged to move via the upper linking bar 70A and the lower linking bar 70B that are connected pivotally together with the crank 60 by means of the pivotal shaft 61. So, the driving motor 30 does not need too much power to do the job, with its cost possible to be reduced considerably.

While the preferred embodiment of the invention has been described above, it will be recognized and understood that various modifications may be made therein and the appended claims are intended to cover all such modifications that may fall within the spirit and scope of the invention.

What is claimed is:

1. A vibrating mechanism of a body vibration machine, said mechanism comprising a bottom board, a step and a driving mechanism fixed on said bottom board to enable said step vibrated, said driving mechanism comprising:
two upper linking bars connected with said step;
two lower linking bars connected with said bottom board;
plural direction-restricting sets correspondingly installed between said step and said bottom board, each said direction-restricting set consisting of a hollow cylinder fixed on said bottom board and a guiding bar inserted in said cylinder and connected with a bottom of said step to enable said step moved vertically; and,
a driving motor for eccentrically driving a crank that has a pivotal shaft at its other end to pivotally connected together with said upper linking bar and said lower linking bar, said crank able to drive said pivotal shaft and said upper linking bar and said lower linking bar to spontaneously move circularly while driven eccentrically by said driving motor, said step thus only possible to move vertically because of said direction-restricting sets.

2. A vibrating mechanism of a body vibration machine as claimed in claim 1, wherein said crank is pivotally connected with one end of an eccentric rod of a large pulley that is driven by a belt connected to a small pulley driven by said driving motor.

3. A vibrating mechanism of a body vibration machine as claimed in claim 1, wherein each said direction-restricting set is provided with a bush fixed on the top of said cylinder, a positioning disc fixed on a bottom of said step and screwed together with a top portion of said guiding bar, and a spring installed between said positioning disc and said bush to mount around said guiding bar.
